(19) United States
(12) Patent Application Publication
(10) Pub. No.: US 2010/0301596 A1
(43) Pub. Date: Dec. 2, 2010

(54) COUPLING FOR INTERCONNECTING AT LEAST TWO PIPES

(75) Inventors: Armin Amann, Schlins (AT); Wilhelm Sonderegger, Dornbirn (AT)

Correspondence Address: VOLPE AND KOENIG, P.C., UNITED PLAZA, 30 SOUTH 17TH STREET, PHILADELPHIA, PA, 19103, US

(73) Assignee: A&S UMWELTTECHNOLOGIE AG, Appenzell (CH)

(21) Appl. No.: 12/797,842

(22) Filed: Jun. 10, 2010

Related U.S. Application Data
(63) Continuation of application No. PCT/AT2008/000438, filed on Dec. 9, 2008.

(30) Foreign Application Priority Data
Dec. 14, 2007 (AT) A2040/2007

(51) Int. Cl. F16L 25/00

(52) U.S. Cl. 285/31

(57) ABSTRACT

A coupling for interconnecting at least two pipes (1) of a geothermal heat exchanger system, including at least one female coupling part (2) and at least one male coupling part (3) that can be inserted therein, with at least one fluid seal (4) being provided between the coupling parts (2, 3) for sealing the coupling parts (2, 3), especially in a fluid-tight manner. At least one, preferably annular or cylindrical, reinforcing element (5) supports at least one of the two coupling parts (2, 3), preferably at least the female coupling part (2), so that the coupling part (2, 3) is not radially deformed, preferably not radially expanded, and is produced of a material or material composition different from that of the coupling part (2, 3).

### CROSS-REFERENCE TO RELATED APPLICATIONS

This application is a continuation of PCT/AT2008/000438, filed Dec. 9, 2008, which claims the benefit of Austrian Patent Application No. A2040/2007, filed Dec. 14, 2007, both of which are incorporated herein by reference as if fully set forth.

### BACKGROUND

The present invention relates to a coupling for interconnecting at least two pipes of a geothermal heat exchanger system, having at least one female coupling part and at least one male coupling part that can be inserted therein, with at least one fluid seal being arranged between said coupling parts, particularly a fluid-tight one, for sealing the coupling parts.

Geothermal heat exchanger systems are arrangements made, at least partially, to contact the ground for interaction and/or thermal exchange, preferably at least partially buried in the ground. Such geothermal heat exchanger systems may comprise geothermal exchangers, geothermal probes, geothermal collectors, and the like as well as other tubular elements entered into the ground or representing connection pipelines to buildings or facilities or installations. By the heat exchange with the ground or the ground water, heat is transferred to the fluids conveyed in the pipes of the geothermal heat exchanger system in order to use the heat to heat buildings or facilities or installations. Geothermal heat exchanger systems can similarly be used for cooling buildings or facilities or installations. Usually, in such arrangements plastic pipes are used, because on the one hand they are not subject to corrosion or rotting, and on the other hand they can be produced comparatively cost-effectively and are easily processed. Due to the fact that these pipes cannot be produced and processed at unlimited lengths, simply for reasons of transportation, generic couplings are necessary, by which at least two such pipes each of the geothermal heat exchanger system can be interconnected. Such couplings are beneficially produced from plastic as well, because they are also to be produced, to the extent possible, corrosion-resistant, non-rotting, and cost effectively.

Another requirement for such a coupling comprises for its diameter not being considerably larger than the one of the pipes to be interconnected. This way, the material and/or wall thicknesses of the coupling parts are limited.

By filling an assembled geothermal heat exchange system a considerable interior pressure develops in the pipes caused by the fluids conveyed in the pipes, particularly liquids such as water or brine, which permanently acts upon the pipes and the coupling(s). Experience has shown that due to the plasticity of the material used, particularly plastic material, this constant pressure can lead over time to an undesired expansion of the coupling. This either can then result in leaks or, after certain periods of time, in a complete breaking of the coupling can occur.

### SUMMARY

The object of the invention is to provide a coupling of the above-mentioned type in which this problem is eliminated or at least drastically reduced.

This is attained according to the invention in that a reinforcement body is provided, preferably annularly or sheath-shaped, which reinforces at least one of the two coupling parts, preferably at least the female coupling part, against a radial deformation, preferably a radial expansion of said coupling part, and is produced from a different material or a different material composition than the coupling part.

The invention therefore provides for the coupling to be hindered via the reinforcement body to deform over time under the effects of pressure, particularly to expand. This particularly refers to avoiding any plastic deformations. Due to the fact that elastic deformations of the coupling can also lead to leaks, these deformations are also to be restricted, at least to such an extent, that leaks are avoided. Due to the reinforcement body, the coupling maintains its original shape, at least to a sufficient extent, thus eliminating the above-mentioned problems. The reinforcement body is here beneficially produced from a material, which is non-corrosive and cannot rot, either. In order to fulfill its function it is beneficial for the material and/or the material composition of the reinforcement body to show a high fatigue resistance and only minor expansion within the elastic range. This way, the reinforcement body forms a kind of armoring, by which the coupling sufficiently maintains its shape and thus its functionality even under permanent stress.

The term pipe, in the sense of the invention particularly refers to a hollow body, through which liquids or gases can be conveyed. The term pipe is therefore considered comprehensive and particularly excludes any limitations in shape and size of said hollow body. Practically, geothermal heat exchanger systems, particularly geothermal exchangers, geothermal probes, and geothermal collectors are therefore largely and/or essentially assembled from pipes.

In addition to the coupling per se, the invention also relates to a male coupling part for a coupling according to the invention and/or a female coupling part for a coupling according to the invention and/or a reinforcement body for a coupling according to the invention. Furthermore, the invention also relates to a geothermal heat exchanger system having at least one coupling according to the invention and particularly a geothermal heat exchanger system, which in the assembled state comprises at least two pipes interconnected via the coupling. Here, it is preferably provided for the pipes to be made from the same material, preferably the same plastic as the coupling parts, at least in the area, in which they are directly in contact with the coupling parts in the assembled state.

It is preferably provided for the fluid seal and preferably also for any potentially provided additional seal to contact the reinforcement body in the assembled state of the coupling or to be supported thereby and/or to be surrounded thereby.

### BRIEF DESCRIPTION OF THE SEVERAL VIEWS OF THE DRAWINGS

Additional details and features are discernible from the following description of the figures, showing various exemplary embodiments of the invention. Shown are:

FIGS. 1 to 6 are illustrations of a first exemplary embodiment,

FIGS. 7 to 10 are views of various examples of modified potential embodiments of said first exemplary embodiment with different reinforcement bodies, and

FIG. 11 is a view of an exemplary embodiment of the invention in the form of a T-part for interconnecting three pipes.

### DETAILED DESCRIPTION OF THE PREFERRED EMBODIMENTS

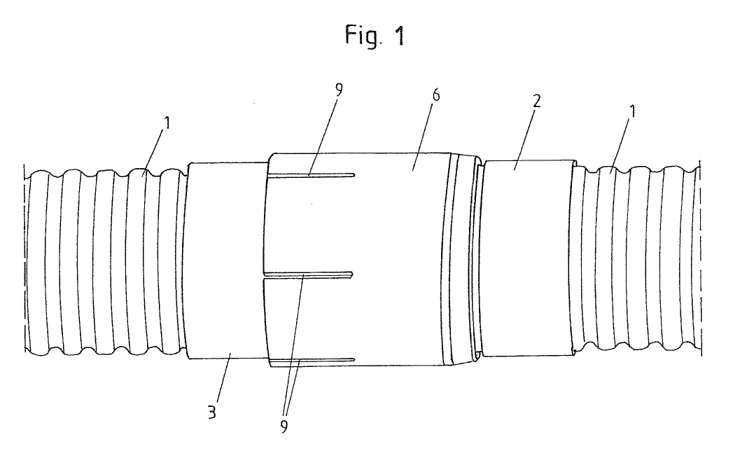

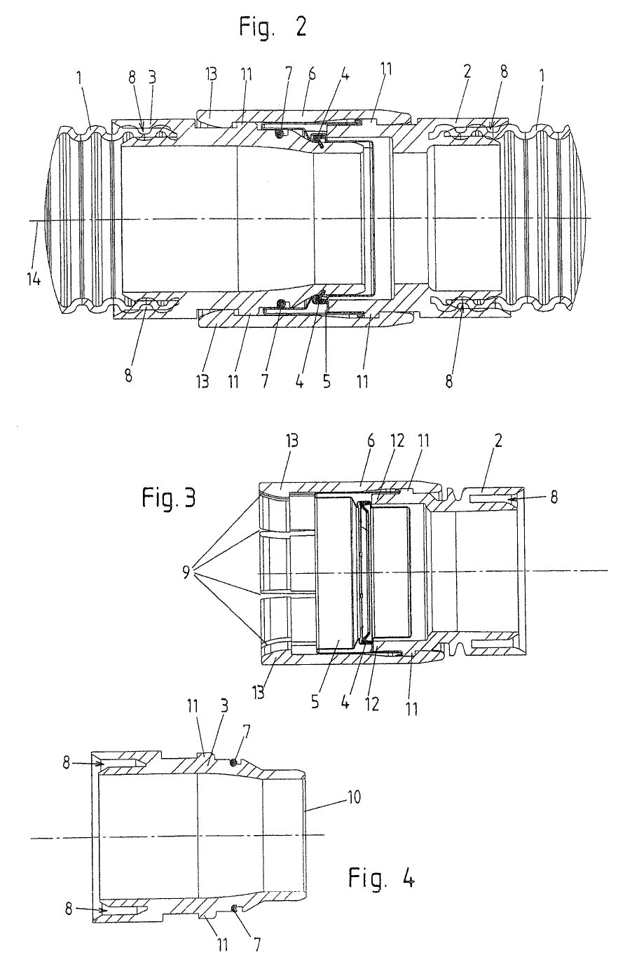

FIG. 1 shows the first exemplary embodiment of a geothermal heat exchanger system in the area of the coupling interconnecting the two pipes 1. FIG. 2 shows a longitudinal cross-section through this arrangement. In the assembled state, as shown in FIGS. 1 and 2, it is provided for all exemplary embodiments shown that the female coupling part 2 and the male coupling part 3 inserted therein are supported and/or fastened in a manner displaceable in reference to each other. In the variants shown the female coupling part 2 and the male coupling part 3 represent a plug-in connection that can be locked in the assembled state. However, this is not mandatory; other form-fitting connections are also possible, such as plug-in connections, screwed connections, connections with bayonet couplings, and the like are also possible in embodiments according to the invention. In all these embodiments it is beneficial for the connection to be detachable, regardless if manually or with the help of a tool, without destroying or damaging the coupling thereby. In order to allow latching the two coupling parts 2 and 3 to each other in the exemplary embodiments shown in the figures, a locking socket 6 is provided, which in the assembled state of the coupling encloses the connecting area between the female coupling part 2 and the male coupling part 3. Here, it is beneficially provided for the locking socket 6, in the assembled state of the coupling, to be held via at least one latching and/or detachable connection on the female coupling part 2 and/or on the male coupling part 3. In the exemplary embodiments shown in the figures the locking socket 6 is arranged fixed to the female coupling part 2. Here, it is received behind the projection 11, preferably embodied as an annular collar. It is particularly clearly discernible in FIGS. 1 and 3 that the locking socket 6 comprises expansion slots 9, forming elastically deformable snap-in pins 13. The male coupling part 3 is automatically locked when inserted into the female coupling part 2, as soon as the projections 11, preferably embodied as an annular collar, are pushed in the direction of the female coupling part 2 to such an extent that the snap-in pins 13 are received behind the projections 11 arranged at the male coupling part 3, as shown in FIG. 2. In this state, the two coupling parts 2 and 3 are latched to each other. The locking socket 6 prevents the two coupling parts to be pulled apart in the direction of the longitudinal axis 14 of the coupling.

In general, it is also possible, here, to use clamps or the like instead of the locking socket 6 in order to interconnect the two coupling parts 2 and 3 in the direction of the longitudinal axis 14. The use of an essentially closed locking socket 6, which more or less completely encloses the area in which the two coupling parts 2, 3 are inserted into each other, is advantageous, though, in that such a locking socket 6 at least partially prevents the permeation of contaminants into the connecting area between the male and the female coupling parts 2 and 3.

The assembled state refers to the state, in which the two coupling parts 2 and 3 are completely inserted into each other such that the fluid seal 4 completely seals the two coupling parts 2 and 3 from each other, and the coupling parts 2 and 3 are fastened to each other.

As already shown, in the first exemplary embodiment according to FIGS. 1-6 the locking socket 6 essentially serves to hold the two coupling parts 2 and 3 together in the axial direction 14. However, in order to prevent any expansion of the coupling parts 2 and 3 in the radial direction, i.e. perpendicular in reference to the longitudinal direction 14 and threatening the sealing effect, the reinforcement body 5 is provided in the exemplary embodiments shown. This body 5 serves to reinforce at least one of the two coupling parts 2, 3, preferably the female coupling part 2, from any radial expansion orthogonally in reference to the axial direction 14. For example, it may be sufficient for the reinforcement body 5 to only reinforce the exterior, thus the female coupling part 2, which simultaneously reinforcing the male coupling part 3 from any excessive radial expansion. Depending on the concrete embodiment of the coupling parts 2 and 3 it may also be provided that the reinforcement body 5 reinforces the male coupling part 3 and the female coupling part 2 or directly the male coupling part 3 and preferably here indirectly also the female coupling part 2 from any radial expansion. For this purpose, the reinforcement body 5 is made from a different material or another material composition than at least one of the coupling parts 2, 3. Accordingly, it is here also beneficial for the reinforcement body 5 to be made from a different material or another material composition than the male coupling part 3 and the female coupling part 2. In general it would be possible to achieve the necessary stability of the reinforcement body by appropriate wall thicknesses.

However, it is preferably provided for the material or the material composition of the reinforcement body 5 to achieve its elastic limit only at considerably higher tensile stress than the material or the material composition of the male coupling part 3 and/or the female coupling part 2. Here it is particularly preferred for the elastic limit of the material or the material composition of the reinforcement body 5 to be reached at the earliest a tensile stress at least higher by a factor of 4, or even more preferred by at least a factor of 10, or by at least a factor of 40 in reference to the elastic limit of the material or the material composition of the male coupling part 3 and/or the female coupling part 2. The elastic limit here refers to the value of the mechanical tensile stress resulting in deformation when exceeded. In the stress-strain diagram this marks the point at which the stress-strain curve deviates from a linear progression of the elastic range. The material features, such as the permissible tension and compression resistance under continuous load, are generally known for the materials and/or material compositions considered for producing the reinforcement body, such as metals, fiber-reinforced plastics, and the like. In order to achieve a reliable long-term stability sufficient safety shall be considered in the sizing of the material cross-section of the reinforcement body 5. Ultimately it is beneficially provided that during operation the reinforcement body 5 is exclusively deformed elastically at the coupling by way of tensile forces occurring due to weight and pressure.

When plastics are used, such as polyethylene, particularly PEHD, polypropylene, polybutylene, or PVC, to produce the male coupling part 3 and/or the female coupling part 2 the tensile stress, at which these materials reach their elastic limit at room temperature and normal atmospheric pressure, amounts to approximate 10 N/mm². In the sense of the above-mentioned factors 4 and/or 10 then for the production of the reinforcement body 5 beneficially a material and/or a material composition is used, which at room temperature and normal atmospheric pressure is still exclusively elastically deformed at a tensile stress of at least 40 N/mm², preferably at least 100 N/mm², without any plastic deformation remaining when released. For the preferred factors 30 and/or 40 a material and/or a material composition is used for the reinforcement body which is still exclusively deformed elastically at room temperature and normal atmospheric pressure under tensile stress of at least 300 N/mm², preferably at least 400 N/mm².

Preferably it is provided for the reinforcement body 5 to enclose and/or support at least the female coupling part 2, preferably both coupling parts 2, 3, in an annular or sheath-like fashion. In the first exemplary embodiment according to FIGS. 1 through 6 the reinforcement body 5 is embodied in the form of a double-walled socket, which is pushed onto the end 12 of the female coupling part 2 pointing to the male coupling part 3 and which is tightly compressed therewith. In this exemplary embodiment the reinforcement body 5 is embodied such that the male coupling part 3 is inserted into the sheath-like reinforcement body 5. In this variant, the reinforcement body 5 also represents the carrier of the fluid seal 4. This serves to completely seal the coupling so that in the assembled state of the coupling no fluids can permeate from outside to the coupling and inversely no fluids can leave the coupling from the inside towards the outside. Here, the fluid seal 4 beneficially comprises a sealing lip, as shown in the figures, which in the assembled state of the coupling contacts the male coupling part 3 at the exterior contour over its entire surface and in an annular fashion and thus permanently ensures sufficient sealing. Other forms of seals are also possible, such as O-rings. The embodiment of the fluid seal 4 is then determined in detail based upon the fluids to be conveyed in the geothermal probe and/or the pipeline system and the pressure range to be covered. Usually these liquids represent for example water or brine, so that an appropriate material should be used for the fluid seal 4, for example rubber.

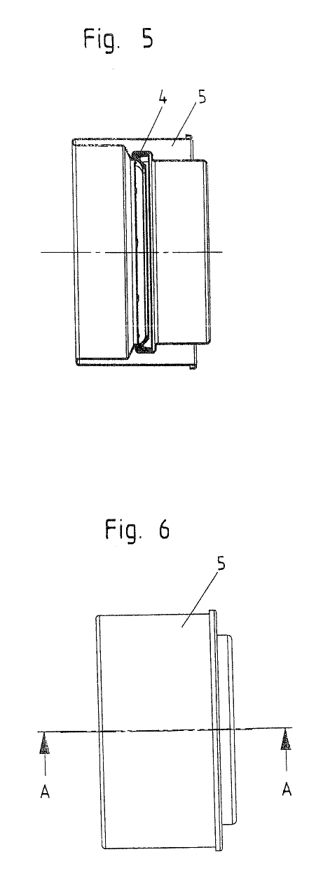

FIGS. 5 and 6 show the reinforcement body 5 of the first exemplary embodiment. Here, FIG. 6 shows a side view. FIG. 5 shows a cross-section along the cutting line AA of FIG. 6.

FIGS. 3 and 4 show the female coupling part 2 and the male coupling part 3 in the disassembled state. Contrary to FIGS. 1 and 2, these two coupling parts are not connected to the pipes 1 in the illustration selected. In order to accept the pipe 1, the coupling parts 2 and 3 each include an annular groove 8, into which the pipe 1 can be pushed or be welded in. Here, it is possible to use most different types of pipes 1. In the first exemplary embodiment, as discernible in FIGS. 1 and 2, this represents so-called corrugated pipes 1. Instead thereof, smooth pipes, burled pipes etc. can also be used, of course. The pipes 1 as well as the couplings are each to be embodied hollow in the sense that liquids or gases can be conveyed through them. The pipes 1 can be fastened in a sealing and pressure-resistant fashion to the two coupling parts 2 and 3 by way of welding, adhesion, screwing, riveting, or other measures known from prior art. However, it is preferred for the pipes 1 and the coupling parts 2 and 3 to be welded to each other, preferably by way of friction welding. For this purpose it is beneficial for the pipes 1 and the coupling part respectively to be fastened thereat to be made from the same material. Thus, beneficially the above-mentioned plastics for the couplings are also used for the pipes 1, although this is not mandatory.

For geothermal heat exchanger systems the couplings and the pipes 1 ought to show interior diameters of at least 25 mm, preferably ranging from 25 mm to 250 mm. The wall thicknesses of the pipes 1 can range from 1 to 10 mm, for example, in order to, on the one hand, allow a heat exchange with the ground or the ground water as good as possible and, on the other hand, to achieve the required stability. In the axial direction the minimum tensile strength of the coupling should amount of at least 4000 N at a pipe diameter of 63 mm, for example. A particularly beneficial embodiment of the geothermal heat exchanger system provides that both, the female coupling part 2 as well as the male coupling part 3, and the locking socket 6, as well as the pipes 1 are made from the same material, preferably the same plastic, by at least 50 percent by volume each, preferably in their entirety. However, it is also possible, of course, only to produce one of the two coupling parts 2 and 3, and, if applicable, the pipes 1 from the same material, equivalently it is possible only to produce only one of the two coupling parts 2 or 3 together with the locking socket 6 from the same material and the other coupling part and, if applicable, the pipes from different materials.

As shown in the first exemplary embodiment, the reinforcement body 5 may represent an initially separately produced part, which preferably can be connected to the female coupling part 2 and/or the male coupling part 3 by way of pushing, compressing, adhering, screwing, or winding. The reinforcement body 4 can here be made from most different materials. The first exemplary embodiment according to FIGS. 1 through 6 provides for example that the reinforcement body is made from metal, preferably steel or stainless steel. Under the interior pressure occurring inside the coupling in geothermal heat exchanger systems such materials react exclusively in an elastic fashion. No plastic deformation occurs because the elastic limit of the materials is not reached. Here, beneficially a safety factor is considered. This way, using the reinforcement body 5 the coupling can be permanently secured from any undesired expansion.

In order to ensure long-term stability it is beneficial, particularly when the coupling is used for geothermal heat exchanger systems, for the material of the reinforcement body 5 to be of appropriately permanent corrosion resistance. In this context the use of stainless steel is recommended for the production of the reinforcement body 5.

When used for geothermal probes, the coupling is surrounded in the operational state externally by dirt, filler material, or concrete or the like. The pipes 1 of the geothermal heat exchanger system are commonly buried, encased in concrete, inserted into predrilled holes and filled in, and/or rammed into the ground via pile-drives or oscillating devices known per se. This may occur, for example, with a ramming rod, internally guided by the pipes 1 and the couplings, which is closed at the bottom with a ramming foot and/or probe foot. Here, usually only the lowermost area of the pipeline is surrounded by a jacket of the probe foot. The remaining pipeline, and thus also the couplings, are otherwise both during the ramming process as well as during the later operational state directly in contact with the dirt, filler material, or concrete. In prior art this repeatedly caused problems by contaminants permeating into the coupling. Particularly during the ramming process dirt, support liquids, or filler material can frequently be pressed directly into the coupling. This can lead to problems for the sealing via the fluid seal 4. In order to prevent this from occurring it may be provided that in addition to the fluid seal 4, provided for particularly sealing in a liquid-tight fashion, an additional seal 7 is provided, which at least in the assembled state of the coupling is arranged at a farther distance from the end 10 of the male coupling part 3, extending into the female coupling part 2, than the fluid seal 4.

Therefore, this additional seal 7 has essentially the function of a dirt shield and prevents the penetration of liquids, filler materials, or other contaminants, carried in from the outside, to the fluid seal 4. This additional seal 7 can be embodied as a sealing ring, preferably a rubber ring, as shown in the present exemplary embodiments. Here, it is beneficial for this additional seal 7 to be supported in an annular groove at the male coupling part 3, as shown in the exemplary embodiments, or at the female coupling part 2, or at the reinforcement body 5, or at the locking socket 6. In the first exemplary embodiment according to FIGS. 1 through 4 this additional seal 7 is arranged between the male coupling part 3 and the reinforcement body 5, in any case in form of a separate component. This is not mandatory, though. As shown in the exemplary embodiments described in the following it is also possible, for example, that in the assembled state the additional seal 7 acts between the male coupling part 3 and the female coupling part 2.

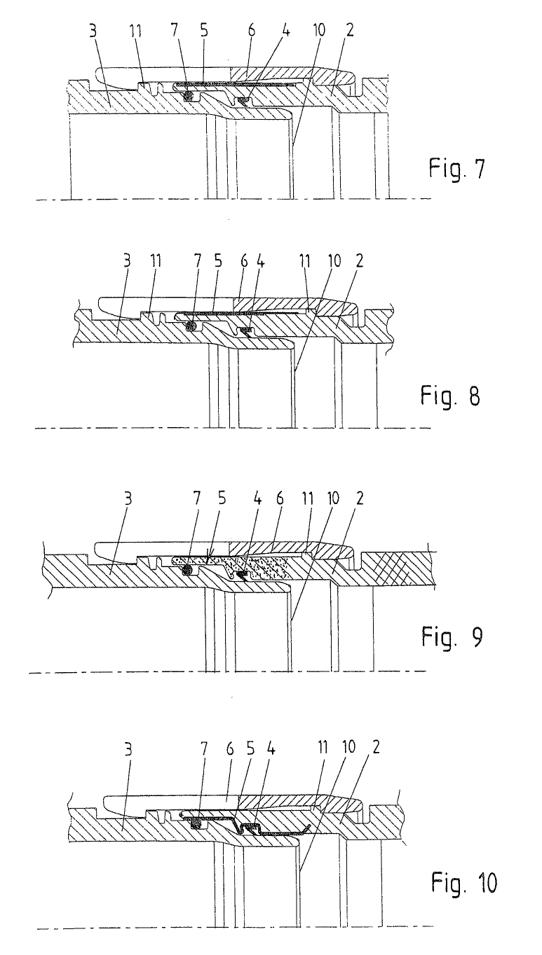

Alternative embodiments are shown in FIGS. 7 through 11. FIGS. 7 through 10 are here cross-sectional illustrations, in which only the upper half of the coupling is shown each in the area of the locking socket 6. In the exemplary embodiment according to FIG. 7, a multi-layered winding of the female coupling part 2 is shown, made from preferably continuous fibers, to form the reinforcement body 5. The reinforcement body 5 extends here essentially over the area in which the male coupling part 3 can be inserted. This winding can be produced as a separate part, plugged or pressed or glued onto the female coupling part 2. However, it is also possible to directly wind or laminate the plastic tape and/or fibers forming the reinforcement body directly onto the female coupling part 2 such that this way, if applicable by a heat treatment, a one-piece connection develops between the female coupling part 2 and the reinforcement body 5. For example, fiberglass or carbon-fiber reinforced plastics can be used for example for the fiber-reinforced plastic tape. The dimensional stability and size accuracy required for the desired long-term behavior is achieved by the material selection and the number of layers and/or windings. It is particularly preferred if the reinforcement body 5 formed from fiber-reinforced plastic tape can still be exclusively deformed elastically at a range of tensile strengths amounting to at least 300 or 400 N/mm².

FIG. 8 shows another variant. Here, at the exterior of the female coupling part 2, a metallic or non-metallic socket is applied in a form-fitting, force-fitting, or material-fitting manner, with the material and the embodiment of the socket being embodied such that the required dimensional stability and size accuracy of the diameter is upheld for the desired long-term behavior. This socket, forming the reinforcement body 5, is particularly preferred still exclusively elastically deformable at a range of tensile strengths amounting to at least 300 or 400 N/mm².

In the exemplary embodiment according to FIG. 9 an area of the coupling part, here the female coupling part 2, is produced in the two-component method. For this purpose, suitable additives, such as reinforcement fibers, are added to the material of the coupling part, which increase the tensile strength and adjust the elastic features as desired. FIG. 9 shows in an exemplary fashion that the reinforcement body 5 may also be formed in one piece at the female coupling part 2. In this exemplary embodiment the reinforcement body 5 resulting therefrom is modified by the above-mentioned additives in its material features such in reference to the remaining material of the respective coupling part that its elastic limit is at a considerably higher level than the elastic limit of the remaining material and/or plastic of the coupling part and thus the required safety is ensured for the desired long-term behavior. As already indicated, a male coupling part 3, as already described for the female coupling part 2, can be provided with a reinforcement body 5 formed in one piece thereat in the two-component method.

FIG. 10 shows another variant of an exemplary embodiment. Here, a metallic or non-metallic insertion part is inserted into the female coupling part 2 as a reinforcement body 5. This insertion part can then serve, in addition to its reinforcing function, as a sealing surface and/or to accept seals. The desired dimensional stability is ensured by an appropriate material selection of said insertion part. The elastic limit of the insertion part is once more higher than the elastic limit of the remaining coupling, in particular considerably higher.

Although it is not explicitly shown here, it shall be pointed out that the reinforcement body 5 can also be integrated in the locking socket 6, or the locking socket 6 may directly form the reinforcement body 5 by an appropriate material selection. In this case, the locking socket 6 interconnects the two coupling parts 2 and 3 not only in the axial direction by also prevents any undesired expansion of the female coupling part 2 in the radial direction.

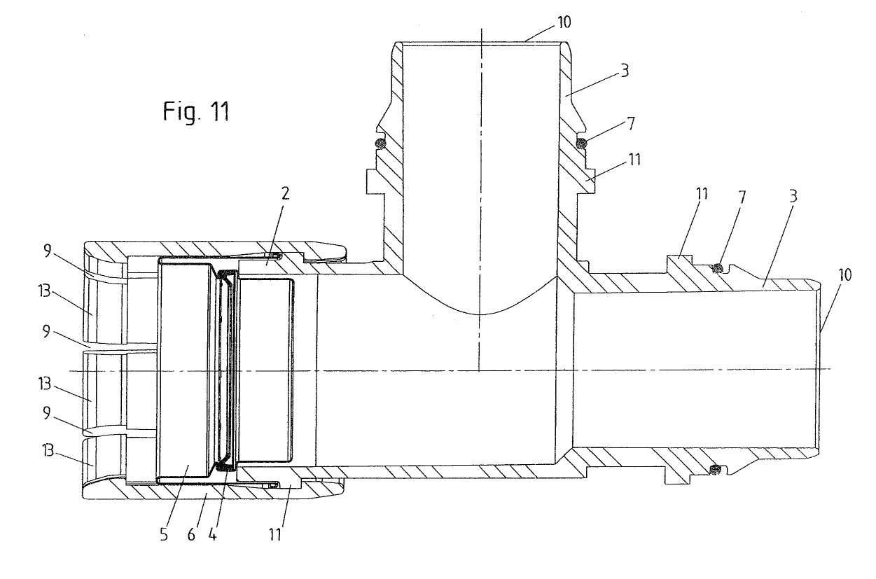

While the above-described couplings serve to always connect only two pipes 1 to each other, the exemplary embodiment according to FIG. 11 shows in an exemplary fashion that it interconnects more than two pipelines. FIG. 11 shows a T-piece, to which three pipes 1 can be connected. The T-piece comprises two male coupling parts 3 and one female coupling part 2. However, this again is only an example, the number and the embodiment of the coupling parts can be selected as needed. In the exemplary embodiment according to FIG. 11 the coupling parts, at least with regards to their functionality, are embodied as explained in the first exemplary embodiment.

All couplings shown in the exemplary embodiment can also be embodied such that the seals are supported at the female coupling part 2 and the allocated sealing surfaces are located at the male coupling parts 3 or at the reinforcement bodies 5. An inverse arrangement is also possible, though, just to name a few examples. The seals 4 and 7 can be held at different parts of the couplings, of course.

In general it shall be pointed out that the couplings according to the invention may serve to interconnect pipes 1 of different parts of the geothermal heat exchanger system, such as geothermal probes, geothermal absorbers, geothermal collectors, and/or all types of geothermal exchangers and/or other heat exchangers. Additionally, the couplings according to the invention can also be provided to interconnect geothermal probes, geothermal absorbers, geothermal collectors, and/or all types of geothermal exchangers and/or other heat exchangers by way of installation, and/or to create connections to houses or to accumulators or distributors. The above-mentioned description of the coupling essentially intends for the reinforcement body 5 to prevent any radial expansion of the coupling. Here, it shall be pointed out, though, that the reinforcement body 5 can also serve to prevent any radial compression of the coupling by forces from the outside or any other radial deformation of said coupling.

### LEGEND OF THE REFERENCE CHARACTERS

1 pipe
2 female coupling part
3 male coupling part
4 fluid seal
5 reinforcement body
6 locking socket
7 additional seal
8 groove
9 expansion slot
10 end of the male coupling part
11 projection
12 end of the female coupling part
13 snap-in pin
14 longitudinal axis

1. A coupling for connecting at least two pipes of a geothermal heat exchanger system comprising at least one female coupling part and at least one male coupling part that can be inserted therein, at least one fluid seal is provided between the at least one female and the at least one male coupling parts to seal the coupling parts, at least one sheath-shaped reinforcement body reinforces at least the at least one female coupling part against a radial expansion of said female coupling part and is formed from a different material or a different material composition than said female coupling part, wherein the coupling further comprises a locking socket, which in an assembled state of the coupling encloses a connection area between the female coupling part and the male coupling part.

2. A coupling according to claim 1, wherein the reinforcement body reinforces the at least one female coupling part and the at least one male coupling part against a radial deformation of said coupling parts.

3. A coupling according to claim 1, wherein the reinforcement body is formed from a different material or a different material composition than the female coupling part and the male coupling part.

4. A coupling according to claim 1, wherein the material or the material composition of the reinforcement body is exclusively elastically deformable under a tensile stress of at least 40 N/mm².

5. A coupling according to claim 1, wherein the material or the material composition of the reinforcement body is exclusively elastically deformable under a tensile stress of at least 100 N/mm².

6. A coupling according to claim 1, wherein the reinforcement body is annular or sheath-shaped and encloses or encompasses at least the female coupling part.

7. A coupling according to claim 1, wherein the reinforcement body is annular or sheath-shaped and encloses or encompasses the two coupling parts.

8. A coupling according to claim 1, wherein the female coupling part and the male coupling part forming a plug-in connection in the assembled state.

9. (canceled)

10. A coupling according to claim 1, wherein the locking socket in the assembled state of the coupling is held via a form-fitting connection on at least one of the female coupling part or the male coupling part.

11. A coupling according to claim 10, wherein the form-fitting connection is a latching connection.

12. A coupling according to claim 10, wherein the form-fitting connection is a detachable connection.

13. A coupling according to claim 1, wherein at least one of the coupling parts, selected from a group comprising the female coupling part and the male coupling part, comprises plastic.

14. A coupling according to claim 1, wherein the locking socket comprises at least one of metal, plastic or fiber-reinforced plastic.

15. A coupling according to claim 1, wherein at least two of the components, selected from a group comprising the female coupling part, the male coupling part and locking socket, comprise the same material by at least 50% by volume.

16. A coupling according to claim 1, wherein the reinforcement body is comprised of at least one of metal, a ceramic material, fiber-reinforced plastic, or a multi-component plastic.

17. A coupling according to claim 16, wherein the reinforcement body is formed of steel or stainless steel.

18. A coupling according to claim 1, wherein the reinforcement body is an initially separate component, which can be connected to the female coupling part or the male coupling part.

19. A coupling according to claim 18, wherein the reinforcement body is connectable to the female coupling part or the male coupling part by plugging on, compressing, adhering or screwing.

20. A coupling according to claim 1, wherein the reinforcement body is formed in one piece on the female coupling part or the male coupling part.

21. A coupling according to claim 1, wherein, in addition to the fluid seal, provided for sealing, an additional seal is provided, which at least in an assembled state of the coupling is arranged farther away from an end of the male coupling part inserted in the female coupling part than the fluid seal.

22. (canceled)

23. A coupling according to claim 1, wherein the fluid seal is adapted to provide a liquid-tight seal.

24. (canceled)

25. (canceled)

26. (canceled)

27. A coupling according to claim 1, wherein the reinforcement body reinforces the at least one female coupling part and the at least one male coupling part against a radial expansion of the coupling parts.
